(19) United States
(12) Patent Application Publication
(10) Pub. No.: US 2003/0149799 A1
(43) Pub. Date: Aug. 7, 2003

(54) System supporting unified event handling in ECMAScript

(76) Inventors: Scott Shattuck, Westminster, CO (US); William J. Edney, Chesterfield, MO (US); James A. Bowery, Las Vegas, NV (US)

Correspondence Address: J. Mark Smith, Dorr, Carson, Sloan & Birney, P.C., 3010 East 6th Avenue, Denver, CO, 80206, US

(21) Appl. No.: 10/138,607

(22) Filed: May 3, 2002

Related U.S. Application Data
(60) Provisional application No. 60/288,385, filed on May 3, 2001.

(51) Int. Cl. G06F 9/46

(52) U.S. Cl. 709/318

(57) ABSTRACT

A system implementing unified and extensible event handling in ECMAScript is described. The current capturing, bubbling, and DOM Level 2 systems of UI event handling are unified without requiring upgraded or altered browsers by leveraging JavaScript to create data structures and processes which capture and realign these disparate systems of event handling. Object dependency is supported through the same unified event system which resolves the differences between capturing, bubbling, and DOM Level 2 event models while integrating non-UI and distributed event support resulting in a system capable of supporting MVC patterns. The particular advantage of the described system is that the implementation is in JavaScript and requires no applets, plugins, or other alterations to currently deployed web browsers.

The applicant claims priority of Provisional patent application Serial No. 60/288,305, filed May 3, 2001, entitled “A METHOD SUPPORTING ADVANCED OBJECT-ORIENTED PROGRAMMING IN JAVASCRIPT”, inventors, Scott Shattuck, et al.

### REFERENCE TO A MICROFICHE APPENDIX

The source code is included with this application on Microfiche.

### BACKGROUND—FIELD OF INVENTION

A Glossary of Terms

Function:

A process encoded in software which performs some activity and returns a value as a result. Based on the mathematical definition of function.

Procedure:

A process encoded in software which performs some activity but may or may not return any data values. Some programming languages make a distinction between functions and procedures based on whether output is produced.

State:

Information or data. Can be persistent (across multiple invocations of a program) or transient (existing only for the life of a single program).

Behavior:

Capabilities, processes, or functions. A collective noun referring to the combined functionality offered by a particular object.

Object:

A software construct intended to encapsulate state and behavior in a unified form. Traditional software separates functions from the data on which they operate. This separation of behavior (the functions) and state (the data) often led to inconsistent or inaccurate processing of information.

Instance:

A uniquely identifiable individual object. A single person, single account, single address, etc.

Property:

An individual aspect, element, or characteristic of an object. No particular subdivision between state or behavior is implied.

Attribute:

An individual aspect, element, or characteristic of an object. Typically used to refer only to state-bearing properties of an object.

Method:

A function or procedure that has been bound to a specific instance of an object. Object-oriented languages typically include an automatic mechanism for function and procedure invocation which include passing a reference to a specific instance to the function/procedure thereby “binding” the function to the instance. This reference is accessed with methods via a well-known name, typically “this” or “self”.

Class:

In object-oriented terms, a factory for the construction of individual instances of related items. For example, People, Employees, Department, etc. are classes while you, I, Department 10, etc. are instances. Most object-oriented languages utilize a “new” keyword or function as in “new Department ( )” or “Department.new ( )” to construct instances. As a way of grouping properties conveniently the state and behavioral capabilities of instances are typically associated with the Class.

Type:

A synonym for class in most object-oriented languages.

Prototype:

An object used specifically as a template, often literally “cloned” to create new instances. Each instance so created has (at least in principle) separate memory space for both state and behavioral properties. This differs from Classes in that most class-based languages create an empty memory structure to hold the state of an instance but retain a single shared copy of the behavior/methods. For optimization reasons most prototype-based languages also hold a single shared copy of properties until an operation on the instance would alter the value. At that time the new value is updated on the instance rather than altering the shared value. This process is often referred to as “copy-on-write” since no copy of the properties is made until a “write” rather than a read occurs.

Message:

A specific method invocation request. While a method is a function such as “processPayroll” which can take parameters etc., a message is a specific request to invoke a method. Therefore a message includes information about specific parameter values etc.

Constructor:

A specific form of method used to initialize the memory of newly created instances. In class-based languages instances are typically created with an empty block of memory to hold the state. A two-step process is typically employed in these languages which separate “allocation” from “initialization”. After allocation via the “new” keyword or similar process most languages invoke an initialization function on the newly created instance. This initialization function is referred to as a constructor.

Inheritance:

A term referring to the ability of object Classes or Types to be arranged in hierarchies such that members lower in the hierarchy “inherit” behavior from their parent Classes or Types. A foundational element of the Object-Oriented paradigm. Inheritance is rarely considered complete or true if specialization is not also supported. This refers to the ability of new “subtypes” to alter or “override” the behaviors they inherit from parents.

Encapsulation:

A term referring to the goal of hiding from external parties “how” a particular behavior is accomplished. By hiding implementation details programs are made more modular and less likely to have errors. A second core tenet of Object-Oriented programming. A specific example would be calculation of age. Two mechanisms are possible from a state perspective. First, an instance might store the actual age as in 42. Second, the instance might store the birth date and perform a calculation relative to the current date to derive age when queried. Encapsulation implies that requestors are provided simply with a “getAge” method interface. The details of how age is calculated are “encapsulated” with the object and not made public, thereby avoiding unnecessary dependence on specific implementation details.

Polymorphism:

A specific term referring to the ability of objects of different Classes or Types to respond via different methods to the same message. Using our “getAge” example from the encapsulation discussion instances of people might store a birthday and compute on the fly while instance of wine might hold a number of years. Often associated with inheritance since specialization through overriding of parent behavior is a clear example of polymorphism. However, polymorphism does not strictly require an inheritance relationship to exist between the types being considered.

This invention relates to programming in ECMAScript, commonly known as JavaScript; specifically to a system supporting unified event handling in ECMAScript and its derivatives.

### BACKGROUND—DESCRIPTION OF PRIOR ART

ECMAScript natively supports an event-based programming model for document object model (DOM) events.

The original development of ECMAScript was driven by a desire to make web pages more interactive. To accomplish this task extensions to HTML which defined a standard set of DOM events were made. When these DOM events are triggered the function or “handler” (if any) registered for that event is invoked and supplied with the event in question. Registration for a DOM event in the current ECMAScript environment involves defining the function which should handle a particular event as a property of the DOM object which will signal the event. Registration can happen statically by defining the function as an attribute of the HTML element in the HTML document text or by installing the function as a property of the originating object dynamically using ECMAScript.

Using the static HTML mechanism the following example registers a handler for the onunload event of a web page (the DOM document object):

<html>

<body onunload=“javascript: alert(‘unloading’)”>

</body>

</html>

In the previous example, the HTML body tag has been instrumented with an inline piece of ECMAScript which will act as a handler for the onunload event. When the page unloads and the onunload event is triggered by the browser the ECMAScript handler will be invoked and an alert panel will be displayed containing the text “unloading”. This pattern of modifying the HTML directly can be used to add handlers for any of the events defined for HTML tags which support events. The specific events available for any particular tag vary from environment to environment (Internet Explorer and Netscape Navigator support different sets) but a core set of events is defined by the HTML standard which can be used across all compliant environments.

If the static HTNML modification approach is undesirable the ECMAScript programmer can install and uninstall DOM event handlers dynamically from within ECMAScript. To install the previous onunload handler the programmer could have used the following syntax once the page had finished loading:

window.document.onunload=function ( ) {alert(‘unloading’);};

or

var f=function( ) {alert(‘unloading’);};

window.document.onunload=f;

In this case we've dynamically assigned an onunload handler which will be called when the web page is unloaded. The function can be declared inline or it can already exist as shown in the second sample. All DOM objects expose their event handler properties in a similar fashion so that it is possible to install and uninstall event handlers dynamically from ECMAScript via the DOM. Uninstalling a handler is a simple matter of assigning a null value to the desired handler property.

DOM Event Propagation

One issue that arises with respect to DOM events is the question of event propagation. When a DOM event is triggered that event propagates through a chain of potential handlers. The elements of the chain and their ordering is defined by the HTML/DOM structure of the document itself. The nature of the propagation process can have profound effects on when—or whether—a particular event handler is triggered. To understand propagation it's important to understand how HTML pages are constructed since the structure of the document defines to a large extent how events triggered in the document will be propagated.

Web page contents, are arranged in a hierarchy such that each element on a page is nested within an enclosing element with the outermost enclosing element being the document itself. The relationship defined by the HTML/DOM hierarchy is one of “containment” rather than “inheritance”. An HTML document contains a BODY, the BODY may contain a FORM, the form may contain an INPUT element and so on. INPUT elements don't inherit from FORM, nor does FORM inherit from BODY. The two hierarchies, inheritance and containment, are orthogonal. When ECMAScript DOM events propagate they follow the containment hierarchy of the document, not an inheritance hierarchy. This is due in large part to the exclusive focus of ECMAScript events on DOM event processing. For DOM events the containment-based propagation model is appropriate. Unfortunately, at the time of this writing Internet Explorer and Netscape Navigator—the two primary environments for ECMAScript DOM programming—propagate events by traversing the DOM containment hierarchy in completely opposite directions.

In Internet Explorer versions 4 and later, events propagate using a model known as event bubbling. In event bubbling the innermost element of the containment hierarchy receives the event first and, based on how it processes the event, the event is then optionally passed to each of the containing objects for processing until the outermost object, the document, is reached. Using event bubbling each handler has the opportunity to stop the bubbling process by setting a flag which tells the event processing system to stop propagation of the event. This implies that if an event handler is placed on the window object that handler may never be called if event handlers on specific objects within the document stop propagation before the event bubbles to the top.

Netscape Navigator versions prior to version 6 follow the exact opposite model—a model known as event capturing. In Netscape, the outermost element is given the first opportunity to handle the event which is then optionally passed downward through the containment hierarchy until the event finally reaches the innermost element. As with event bubbling, using event capturing it is possible for an outer handler to stop propagation of the event. In our previous example of placing an event handler on the window object this object could, conceivably capture all events and never allow them to propagate to the lower-level DOM component handlers.

From the example it should be clear that a document with two event handlers, one on the document and one on a button within the document can easily see different behavior depending on which browser is executing the page.

To address this discrepancy and unify the event models of the major browsers, the World-Wide-Web consortium (W3C) has defined a unified standard for future event implementations known as the DOM Level 2 specification. This new model demands that events follow the Netscape model “on the way in” and the Internet Explorer model “on the way out”. In other words, under the DOM Level 2 specification events start with the outermost element and follow the capturing model until they reach the innermost element after which they bubble back out to the outermost element in the containment hierarchy. Along the way the event can be stopped by any of the handlers involved. If the document structure is modified after the event triggers the structure in place at the moment the event was triggered is used. Netscape 6 and Mozilla use this model—which it should be noted is not compatible with either of the previous models.

Sadly, until such time as all browsers are upgraded to versions which support the DOM Level 2 event model the situation will get worse—not better. With the deployment of Netscape 6 and the Mozilla browser there are now three (3) separate and incompatible event processing models in effect for DOM-related events. Given the slowing pace of browser upgrades it is difficult to predict when a unified model for event notification will be deployed market-wide.

The inability of ECMAScript developers to program to one event model severely limits the scope of event-based programs which can be constructed. Programming sophisticated event-based applications in today's browser environment requires creation of three separate sets of logic.

While pre-DOM Level 2 browsers remain the market-share leaders there remain several limitations to the event registration process which further limit event-based programming. First, since each handler is a function which must be assigned directly to the originating object it should be clear that only one handler can be registered for a particular event. Second, there is no unified method for observing all events from a particular source regardless of their type. Third, there is no unified method for observing all events of a particular type regardless of their source. Fourth, in cases where multiple observers are desired there is no mechanism for controlling the order in which they are notified or other constraints on whether or when they should be triggered. Finally, there is no model for incorporating or coordinating event logic with non DOM elements.

The DOM Level 2 specification does little to address these limitations. Under the In DOM Level 2 specification registration for events has been changed to follow the Java Swing model of registering event “listeners”. In the DOM Level 2 model all events are dispatched to objects which must implement the “handleEvent” function. These objects are registered as listeners on the originating object. For example, to observe onclick events from a button you must create an event listener which implements the handleEvento function and register it as a listener with the button. The advantage of this model over current event registration practices is that it does allow multiple listeners to be registered with the same source. Unfortunately, no support for the other limitations just listed—such as observing all events from a source or all events of a particular type—is provided.

Like the current ECMAScript event infrastructure, the DOM Level 2 event model remains DOM object specific. No event handling or notification capability has been added to standard ECMAScript objects such as Array, String, Number, Date, etc. Furthermore, DOM Level 2 events remain unidirectional. While DOM objects signal events they cannot themselves act as listeners. Failure to allow DOM objects to observe events means that even under the DOM Level 2 specification elements of the user interface can not respond to changes in the underlying data they are displaying. This limits the possible mechanisms for creating responsive user interfaces.

In recent years several “management event” systems which include the use of a browser have been described along with various event-based synchronization approaches which support the distribution of events over a computer network.

However, none of these inventions attempt to unify the event model of the current DOM with the proposed DOM Level 2 implementations of events. Neither do these inventions unify the two DOM-specific event models with a more general model applicable for standard objects which can then be applied to the general problems of exception handing, performance optimization, and application construction which occur within ECMAScript.

Model-View-Controller

Since the advent of Smalltalk almost 30 years ago a commonly used programming paradigm known as Model-View-Controller (MVC) has been used to develop graphical applications. In essence, MVC separates responsibility for application tasks into Model objects which contain data, View objects which display Model data, and Controller objects which act in response to user events often in the form of Menus. The connectivity between these components is managed using events making MVC a strongly event-based design pattern.

MVC Model objects are “observed” by potentially multiple View objects such that whenever data in the Model is changed the View(s) are notified via an event and update their display accordingly. Likewise the Controllers observe GUI events which allow them to handing incoming user requests. The use of separate Model objects provides several features. First, because they are not designed to display their data Models can be reused across applications whereas Views can often be application-specific due to their specific GUI requirements. Second, Model objects can ensure that any data which is placed in them meets criteria for accuracy and consistency. This allows multiple View objects to avoid duplicating such data validation effort. This pattern of allowing data to remain in data-bearing objects which are separate from the objects responsible for display generation is unsupportable if Models don't signal state changes.

Given the current and proposed DOM event models it should be clear that event-based MVC design patterns are unsupportable. First, the objects most likely to act as Models namely Arrays, Object(s), Strings, Numbers, etc. do not signal events. Second, the objects which are responsible for display—the document objects—cannot observe events even if the Model objects were able to signal them. The result is an event system which fails to support what is perhaps the most widely accepted design pattern for event-based application development.

Assertions And Exceptions

Prior to ECMA-262 Version 3 (ECMAScript 1.5) ECMAScript did not support an exception handling mechanism. This applies to Internet Explorer prior to version 5.5 and Netscape Navigator prior to version 6. In all browsers prior to these versions no built-in exception handling existed. With Navigator 6/Mozilla and Internet Explorer 5.5 support for the ECMA-262 Version 3 mechanism of exception handling was provided.

The ECMA-262 Version 3 specification defines exception handling modeled on the try/catch behavior used in Java in which a particular block of code can be wrapped as follows:

```
try
{
  ... code which may throw an exception ...
}
catch (Exception)
{
  ... code to potentially handle the exception ...
}
```

The try/catch model is also part of the evolving ECMA-262 Version 4 specification otherwise known as ECMAScript 2.0. Although it doesn't support assertions it is likely that this model of exception handling will find its way into the final specification of the next version of ECMAScript.

Unfortunately, there are several limitations with the try/catch model, the primary one being an inability to recover fully if an exception is thrown and properly handled. For example, should an exception be thrown by the first line in a try block there is nothing the programmer can do in the catch block to recover and return control to line 2 of the try block. Although the error may have been corrected and properly dealt with it's essentially too late for the rest of the try block.

The recovery problem with try/catch becomes a larger problem when viewed in the context of “generic” exception handlers. To log all Exceptions which might be thrown it would be nice to write a single routine. One way to write this might appear to be to simply place an exception handler at the top level whose catch block logged the exception and then returned gracefully without altering the flow of control. Because of the recovery problem this mechanism won't work.

Clearly logging every exception is a useful debugging technique. Unfortunately, the try/catch mechanism won't support it without placing a separate function which logs the exception in each and every catch block. The overhead of maintaining this approach is significant and is just one example of the limitations of the try/catch model.

As it turns out, using properly constructed event notification it is possible to support not only bi-directional event notification for the MVC design pattern, but to unify the existing DOM event propagation models in the 4X browsers, support DOM Level 2 semantics in those earlier model browsers, and at the same time support an exception handling system which does not suffer from recovery problems such as those found in try/catch. Moreover, the resulting event objects can be transported remotely creating the necessary support for distributed event mechanisms.

### SUMMARY

The invention includes a specific arrangement of ECMAScript data structures, objects, and functions which cooperate to create a unified event registration and notification system. This system supports event notifications which can be used by both GUI and non-GUI objects within the ECMAScript environment. Further, the event propagation models of event bubbling, event capturing, and DOM Level 2 propagation are unified under this system. Finally, the same event system forms the basis for functions which provide assertion checking and other exception handling constructs as well as particular types of performance enhancement.

Objects and Advantages

Accordingly, several objects and advantages of the invention with respect to notification are:

addition of event notification/observation capabilities to non-DOM objects

unification of the event propagation models of event bubbling, event capturing, and DOM Level 2 implementations.

support for assertions and exception handling constructs in non-Edition 3 compliant ECMAScript implementations.

support for integration of observations/notifications to and from remote objects

support for optimization of objects with respect to dynamic lookup overhead which retain the features of dynamism inherent in native ECMAScript.

Other objects and advantages of the invention with respect to notification are: p1 a single programmatic interface for registration/removal of interest in events regardless of whether they originate from GUI or non-GUI objects is provided

observing/ignoring all events of a particular type regardless of origin can be performed with a single command

observing/ignoring all events from a particular origin regardless of type can be performed with a single command

observing/ignoring all events regardless of type or origin can be performed with a single command

control over the event propagation model is provided by using customizable “policy” functions which determine the event dispatch logic.

control over the event registration process is provided by using customizable “policy” functions which determine the registration process logic

control over the registration removal process is provided by using customizable “policy” functions which determine the removal process logic.

propagation via DOM-Level 2 model is supported in pre DOM-Level 2 browsers.

events can propagate to/from observers outside the client without alteration of the programmatic interface or the installation of plug-ins or applets

use of registration and removal events means only signal function is a primitive unlike previous systems which have three: register, remove, and signal.

Further objects and advantages of the invention will become apparent from a consideration of the drawings and ensuing descriptions.

### DESCRIPTION OF DRAWINGS

FIG. 1-A displays a flow chart defining processing during event registration or “observation”

FIG. 1-B displays a flow chart defining processing during registration removal or “ignoring”

FIG. 2 displays a flow chart defining processing during signaling using the default firing policy.

FIG. 3 defines the signal type hierarchy for the pre-defined signal types which are fundamental to the operation of the invention.

### DESCRIPTION OF INVENTION

The core data structure for the notification aspects of the invention is known as the “signal map”. The signal map stores data extracted from individual “event registration” objects or “registrations” which define one or more signal origin/signal type pairs as well as the function or “handler” to invoke should registration criteria be met. An optional “guard” may also be stored to control access to the handler.

The signal map is composed of nested data structures which support the ability to access registration data by signal origin, by signal type, and by any combination thereof. Within each map location specified by a signal origin/signal type pair the registration storage is segmented by whether the registration is a capturing or non-capturing (potentially bubbling) event registration. This segmentation provides faster response for dealing with DOM style event propagation. Construction of the initial signal map data structures is performed as follows:

// create the signal map within the type system supported by
// A Method Supporting Improved Inheritance And
Reflection In ECMAScript
TPObject.addSubtype(‘TPSignalMap’);
// define the top level dictionary for the signal map
TPSignalMap.$interests = {};
// define a sub-dictionary for tracking observations of “any” type
TPSignalMap.$interests[‘$any’] = {};
// define a sub-sub-dictionary for observing all events from all origins
// and populate that layer with arrays to contain the capturing and non /
// capturing event registrations.
TPSignalMap.$interests[‘$any’][‘$any’] = {‘$cap’:[], ‘$non’:[]};

The signal map constructed here allows signal registrations to be found via their signal type/origin pair and for those registrations to be filtered by capturing vs. non-capturing behavior. Alternative structures are possible wherein the order or names of the keys might vary etc.

Signal map content is dynamically updated as the system processes registration (Observe) and removal (Ignore) events. Whenever a registration is performed the signal map is checked and if necessary a new set of data structures for holding registrations for the signal type specified is created. Creation of new signal map dictionary for aSignal creates the following data structures:

signalMap.$interests[aSignal]={ };

signalMap. $interests[aSignal][‘$any’]={‘$cap’:[ ], ‘$non’: [ ]};

As shown, the top level $interests dictionary managed by the TPSignalMap type contains a key for each signal type being observed. The value for each signal type key is a second dictionary whose keys are object identifiers or OIDs for the various signal origins which are being observed. For objects which are DOM objects the object identifier consists of an optional document ID and the object's HTML element ID. When present, the document ID is composed of an optional window ID and a URL. When present, the window ID allows the system to differentiate between events originating from separate windows displaying the same URL while the URL defines an HTML file containing elements. For non-DOM objects the ID is simply a unique ID.

Management of the IDs for DOM and non-DOM objects is performed by four functions: setID( ), getID( ), $getOID( ), and $generateOID( ). The setID( ) and getID( ) functions work to allow the programmer control over the ID of an object. While the invention provides support for system generated OID values the setID( ) and getID( ) functions work to allow the programmer control over an object's ID. This allows certain objects to be assigned well-known public names rather than random OID values. Signals, origins, handlers, and guards may all be stored via their ID.getID=function( )

{

/**
Returns the public ID of the receiver. If the receiving object doesn't
have an ID set the objects'OID is returned instead. See getOID for
more info. For UI elements in the DOM this method will return the
ID=“val” value.
*/
return (this[‘$id’] == null) ? this.$getOID( ) : this[‘$id’];

};
setID = function(anID)
{

/**
Sets the public ID of the receiver. Public IDs are useful as handles
for acquiring objects from the instance dictionary. By allowing the
developer to set a public ID “well-known” instances can be tracked.
*/
// default invalid entries to the OID
anID = defaultIfInvalid(anID, this.$getOID( ));
this.$id = anID;
return this.$id;

};
$getOID = function( )
{

/**
Returns the unique object ID for the receiver. If the object doesn't
yet have an ID one is generated and assigned.
*/
if (this[‘$oid’] == null)
{

this.$oid = $generateOID( );

};
return this.$oid;

};
$generateOID = function( )
{

/**
Generates an OID value. An OID value is a random identifier
which has
no long-term uniqueness properties but which is sufficient for keeping
a key for objects during a particular invocation.
*/
return String(‘$’ + Math.round(new Date( ).getTime( ) *

Math.random( ) +
Math.random( ))).concat(“0000”).slice(0,14);

};

To unify the two ID namespaces a higher level function getObjectWithID( ) is defined by the invention. When executed this function searches for a non-DOM object with that ID in a public-instances dictionary and then attempts to locate a DOM element with that ID via the document's getElementById( ) function. The public instance dictionary is a simple dictionary whose keys are object ID's and whose values are the objects themselves. This approach is sufficient to allow objects of both DOM and non-DOM types to be found via a string ID. Storing object references as strings avoids garbage collection issues.

getObjectWithID = function(anID)
{

/**
Returns a reference to the public object with the ID provided or null
if the object isn't registered.
*/
return this.$publicObjects[anID] != null?

this.$publicObjects[anID]:
window.document.getElementById(anID);

};

Controlling access to the signal map are a set of functions referred to as “policies” which handle registration and removal of observations as well as map traversal and to triggering of handlers. A set of pre-defined policies supporting these operations is attached to the TPSignalMap type as type variables. These pre-defined policies include two registration policies for capturing and non-capturing event registrations; two removal policies for capturing and non-capturing event registration removal; and three “firing policies” which handle signal map traversal, matching signals to registrations, and notifying i.e. activating the handlers whose registrations match the signal in question. The pre-defined policies are covered in detail in the OPERATION section.

The registration data contained in the signal map is compared during the firing or notification process with information provided to a standard signaling function:

signal(origin, signal, context, policy, additionalArguments)

The first three parameters correspond to the classic “who”, “what”, “where” pattern and define the origin (who), the signal (what), and the signaling context (where) for the event. The origin must refer to an object directly or via an ID. The signal may be either a signal type itself or a type name string which can be converted into a signal. The context is a reference to the current execution context typically provided in the form of arguments.callee (a reference to the function in which the signal call is being made built in to ECMAScript). These three properties are sufficient to activate the signaling mechanism.

The policy parameter provided to the signal( ) function defines the firing policy which should be used when processing the signal. This firing policy will control how the signal is matched to registrations and how the actual notification will occur. The policy will actually be invoked using the other parameters such that:

signal(origin, signal, context, policy, additionalArguments); is converted into an equivalent call to the policy scoped via apply( ) to imitate having called:

policy(origin, signal, context, additionalArguments);

The operation of the system from that point on is dependent on the specific logic of the policy in question and the processing performed by any handlers which are invoked by the firing policy.

Two specific event handlers are pre-defined as part of the invention. The Observe signal handler and Ignore signal handler are specially designed handler functions which are invoked whenever an Observe or Ignore event are signaled. The invention implements the registration and removal processes themselves via signaling an Observe or Ignore signal. Making registration and removal signal-driven allows multiple observers of the registration and removal process to be created.

Once initial construction of the signal map is complete the handler entries for the Observe and Ignore signals are added to the signal map manually. When an Observe or Ignore signal is triggered the appropriate handler function is invoked. These handlers are then responsible for triggering the appropriate registration and/or removal policies. Note that the handlers themselves do not manipulate the data in the signal map—only policies do that.

Activation of the registration process involves use of the observe( ) function as in:

```
//  define a handler
var handler = function(sig) {alert(‘changed’)};
//  register for notification
observe(someOrigin, ‘OnChange’, handler);
//  reference implementation of the observe function
observe = function(anOrigin, aSignal, aHandler, aPolicy)
{
  return signal(this, ‘Observe’, arguments.callee, null,
          anOrigin, aSignal, aHandler, aPolicy);
};
As can be seen the observe call is simply a wrapper around signaling
an Observe
signal with the proper content. The ignore process follows the
same pattern:
//  remove registration made in prior observe( ) call
ignore(someOrigin, ‘OnChange’, handler);
//  reference implementation of the ignore function
ignore = function(anOrigin, aSignal, aHandler, aPolicy)
{
  return $signal(this, ‘Ignore’, arguments.callee, null,
      anOrigin, aSignal, aHandler, aPolicy);
};
```

As these examples show, registration and removal have been simplified such that there becomes only one primitive operation in the invention's event notification system—signaling an event.

Although registration and removal are simply special cases of signaling and the resulting handler processing their use in the system is essential enough to warrant coverage of their process flows.

Regstration (i.e. Subscribe, Observe)

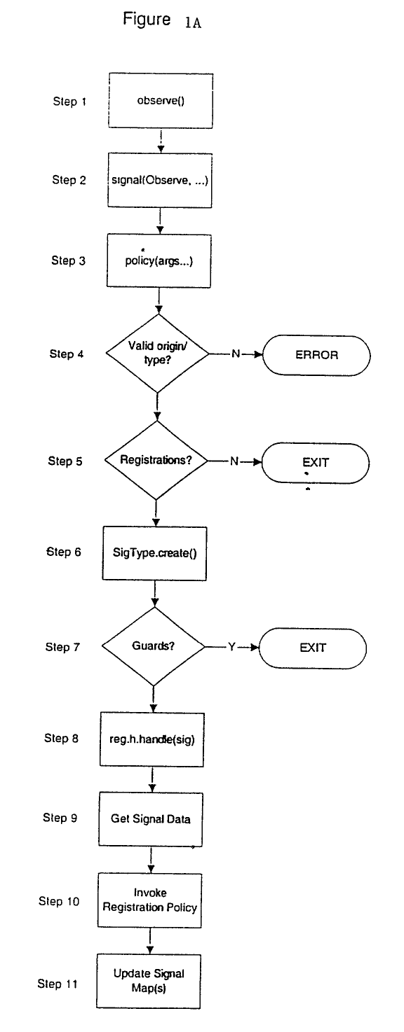

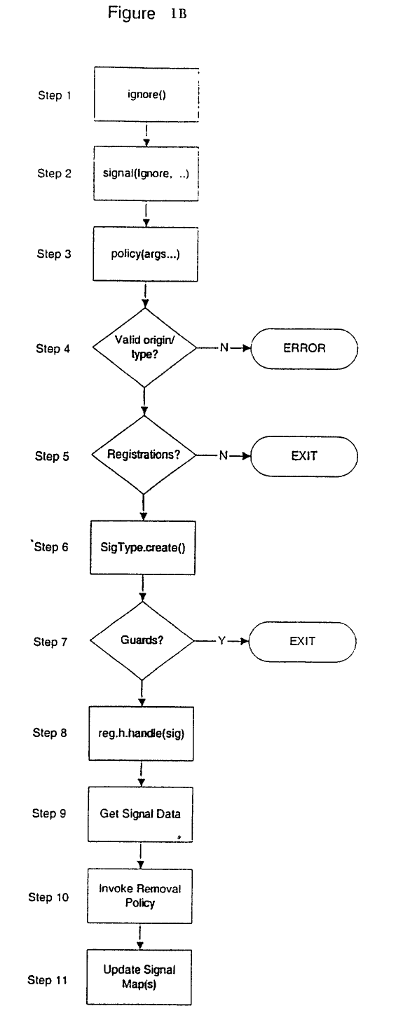

FIG. 1-A defines the steps involved in registering an interest in a particular signal type/origin pair. The process described in FIG. 1-A assumes the Observe signal handler is in place and is the only handler registered for Observe signals.

Step 1 of registration is the invocation of the observe( ) call. This call is assembled by the programmer to contain the desired signal types, signal origins, handler, and optional guard.

In Step 2, the observe( ) function creates a call to signals with a signal type of Observe passing any arguments it receives to the signals call as attributes of the Observe signal. Note that the original signal type/signal origin are now embedded in an Observe signal originating at the observes call.

Step 3 is invocation of the specified firing policy. The signal( ) call generated by observe( ) relies on the DEFAULT_FIRING policy. This policy is invoked with the parameters passed to the signal( ) call—the Observe signal and its content.

Step 4 is pre-firing. During pre-firing the firing policy validates the parameters passed to the policy. This includes verifying the origin and signal type are valid.

Step 5 is registration acquisition. The firing policy, having verified origin and type data now asks the signal map for the map dictionary matching the origin/type combination. This should return a single entry, the pre-built Observe signal handler. If no registrations were found the process exits. Assuming the Observe signal handler was found processing continues with Step 6.

Step 6 is signal instance creation. Before invoking the handler it is necessary to create a holder for the signal's data. This is done by creating an instance of the signal type being fired. In the case of registration this means a new instance of the Observe type will be created and initialized with the argument data provided to the signal( ) call.

Step 7 is guard checking. If a handler has a guard registered the signal instance is first passed to the guard. If the guard returns “true” then the handler should be invoked. If the guard returns false the handler should not be invoked. The pre-built Observe signal handler does not have a guard.

Step 8 is handler invocation. Each handler is invoked by messaging it with the handle( ) function and providing the signal instance as the only parameter. To support this operation both Object and Function have their prototype objects modified to include a handle( ) function. Implementations are as follows:

```
Function.prototype.handle = function (aSignal)
{
  return this(aSignal);
};
Object.prototype.handle = function (aSignal)
{
  var handler;
  handler = ‘handle’ + aSignal.getSignalName( );
  if (isFunction(this[handler]))
  {
    return this[handler](aSignal);
  };
  return this.handleSignal(aSignal);
};
```

The Function implementation simply invokes the function. The Object implementation looks for a function named “handle*” where the asterisk (*) is replaced by the specific signal type name. The OnChange signal would cause lookup of handleOnChange. If that function isn't found the Object implementation forwards to the handleSignal( ) function which simply logs the signal.

With completion of Step 8 the “signaling” portion of the registration process is complete. The remaining portion of the process is actually performed by the Observe signal handler.

Step 9 in the registration process is extraction of the original signal registration data. The Observe signal which triggered invocation of the handler contains the data from the original request including the origin(s), signal type(s), handler, guard, etc. The Observe signal handler extracts this data and for each origin/type pair creates a registration object of the form:

reg={‘o’:origins[i], ‘s’: signals[j], ‘h’:handler, ‘g’: guard};

Step 10 is invocation of the registration policy. The Observe signal handler doesn't actually modify the signal map. Like the rest of the invention it relies on policy objects to interact with the map. The policy used depends on the policy specified in the original observe( ) call. The observe call's policy parameter defines which registration policy should be used. The two pre-built options are for capturing or non-capturing registration. The registration entry created in Step 10 is passed to the policy object as a parameter and invoked as in:

policy(reg);

Step 11 in the registration policy is actual modification of the signal map to store the registration. Once this step is complete signals matching the registration's criteria will invoke the handler registered.

Removal (i.e. Unsubscribe, Ignore)

FIG. 1-B defines the steps involved in removing registration of an interest in a particular signal type/origin pair. The process described in FIG. 1-B assumes the Ignore signal handler is in place and is the only handler registered for Ignore signals.

Step 1 of removal is the invocation of the ignore( ) call. This call is assembled by the programmer to contain the desired signal types, signal origins, and handler.

In Step 2, the ignores function creates a call to signal( ) with a signal type of Ignore passing any arguments it receives to the signal( ) call as attributes of the Ignore signal. Note that the original signal type/signal origin are now embedded in an Ignore signal originating at the ignore( ) call.

Step 3 is invocation of the specified firing policy. The signal( ) call generated by ignore( ) relies on the DEFAULT_FIRING policy. This policy is invoked with the parameters passed to the signal( ) call—the Ignore signal and its content.

Step 4 is pre-firing. During pre-firing the firing policy validates the parameters passed to the policy. This includes verifying the origin and signal type are valid.

Step 5 is registration acquisition. The firing policy, having verified origin and type data now asks the signal map for the map dictionary matching the origin/type combination. This should return a single entry, the pre-built Ignore signal handler.

Step 6 is signal instance creation. Before invoking the handler it is necessary to create a holder for the signal's data. This is done by creating an instance of the signal type being fired. In the case of removal this means a new instance of the Ignore type will be created and initialized with the argument data provided to the signal( ) call.

Step 7 is guard checking. If a handler has a guard registered the signal instance is first passed to the guard. If the guard returns “true” then the handler should be invoked. If the guard returns false the handler should not be invoked. The pre-built Ignore signal handler does not have a guard.

Step 8 is handler invocation. As with the Observe handler, the Ignore handler is invoked by calling handle( ) and passing the handler the signal for processing.

Step 9 in the removal process is extraction of the original signal registration data. The Ignore signal which triggered invocation of the handler contains the data from the original request including the origin(s), signal type(s), and handler The Ignore signal handler extracts this data and for each origin/type pair creates a registration object of the form:

reg={‘o’:origins[i], ‘s’: signals[j], ‘h’:handler};

Step 10 is invocation of the removal policy. The policy used depends on the policy specified in the original ignore( ) call. The registration entry created in Step 10 is passed to the policy object as a parameter and invoked as in:

policy(reg);

Step 11 in the removal process is actual modification of the signal map to remove the registration. Once this step is complete signals matching the registration's criteria will no longer invoke the handler since it is no longer stored in the signal map.

Signal (i.e. Publish, Notify)

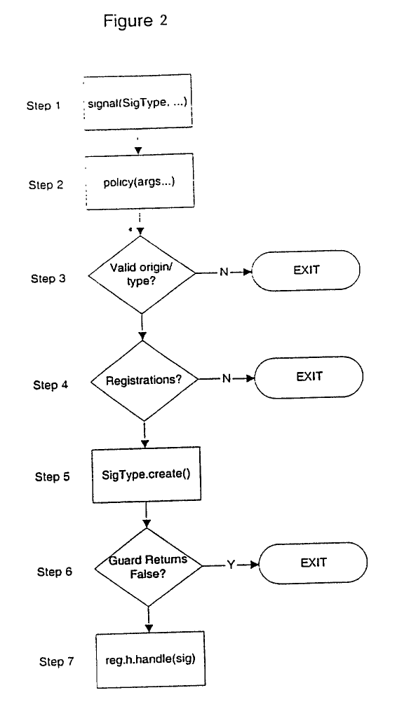

As might be seen from the previous two processes the signaling process consists of seven (7) steps which are described in FIG. 2.

Step 1 of signaling is invocation of the signal( ) function. The signal function takes parameters including the origin, signal type, and context (the who, what, where) as well as a firing policy and optional arguments which should be passed to any handlers which are ultimately notified. The form of this call is:

signal(origin(s), signal(s), context, policy, additionalArguments);

Step 2 is invocation of the specified firing policy. The signal( ) call defaults to the pre-defined DEFAULT_FIRING policy. This policy is invoked with the parameters passed to the signal( ) call such that the effect is as if the original call had been:

policy(origin(s), signal(s), context, additionalArguments);

Step 3 is pre-firing. During pre-firing the firing policy validates the parameters passed to the policy. This includes verifying the origin and signal type are valid.

Step 4 is registration acquisition. The firing policy, having verified origin and type data now asks the signal map for the map dictionary matching the origin/type combination. If no registrations exist the process exits.

Step 5 is signal instance creation. Before invoking the handler it is necessary to create a holder for the signal's data. This is done by creating an instance of the signal type being fired.

Step 6 is guard checking. If a handler has a guard registered the signal instance is first passed to the guard. If the guard returns “true” then the handler should be invoked. If the guard returns false the handler should not be invoked. Additionally the signal itself may have a guard. In this case the signal guard is invoked with the handler. If both guards return true the process continues to Step 7.

Step 7 is handler invocation.Each approved (passed all guards) handler is invoked by calling handle( ) and passing the handler the signal for processing.

Signal Types

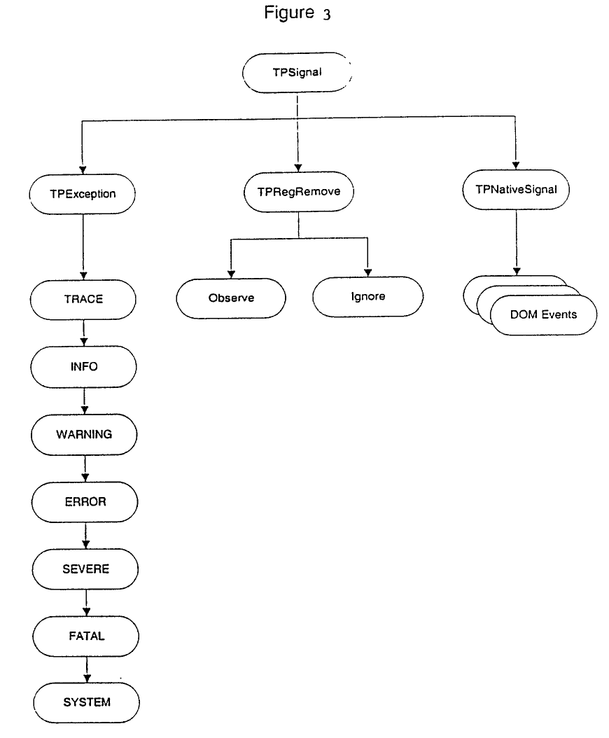

FIG. 3 defines the signal type hierarchy for the pre-defined signal types which are fundamental to the operation of the invention. As shown in FIG. 3, TPSignal is the top level signal type and is the supertype of the pre-defined types TPException, TPRegRemove, and TPNativeSignal.

TPException is the supertype of all signals for which the exception handling system managed by the invention will operate. This includes the signal types TRACE, INFO, WARNING, ERROR, SEVERE, FATAL, and SYSTEM. These signals are themselves arranged in a hierarchy such that observers of ERROR signals will also be triggered when a FATAL signal is received but will not be triggered when a TRACE signal is received. Note that the firing policy which applies to TPException and its subtypes is based on the inheritance hierarchy—not a containment hierarchy as with DOM-related events.

TPRegRemove is the supertype of Observe and Ignore which allows these two signal-map oriented signals to share inherited behavior.

TPNativeSignal is the supertype of all built-in ECMAScript event “peers”. In the context of the invention each ECMAScript event such as “onclick” has been assigned a corresponding signal type. These peer signal types follow a naming convention of using uppercase letters for each word such that onclick becomes OnClick, onchange becomes OnChange, onmouseover becomes OnMouseOver, and so on. Types for each of these built-in events have been created and organized into the hierarchy shown in FIG. 3.

Under the invention, observing a native DOM event is done via the observe( ) call as in:

var handler=function(sig) {alert(‘click!’)};

observe(“okButton”, “OnClick”, handler);

Note that the syntax for observing a native DOM event is identical to observing events from any other origin. This is one of the primary advantages of the invention.

Turning off notification of the button clicks enabled in the previous call is just as straightforward:

ignore(“okButton”, “OnClick”, handler);

The detailed interaction of the invention's event system with the native DOM event system is managed by 1) a top-level document event handler installed on each page which is loaded and 2) individual event handlers added and removed from the origins specified in Observe and Ignore registration events. The individual event handlers are optional depending on the specific browser environment.

The final components defined by the invention are four functions which have exception handling implications: assert( ), attempt( ), die( ), and warn( ). These functions leverage the event system created by the invention to support exception handling capabilities covering pre/post condition testing (assert), exception-based branching logic (attempt), and exception raising capability (die and warn).

Operation of Invention

Use of the invention first requires loading the ECMAScript source code which implements the functionality of the invention into a web-browser or other execution environment capable of executing ECMAScript source code. While the approach used to accomplish this task can vary depending on the particular environment, in the common case of a web browser, the mechanism used can follow one of several forms.

First, the standard HTML <SCRIPT> tag may be used. In this approach the ECMAScript source code implementing the invention can be integrated with any web page by placing the source code in a file—possibly containing other ECMAScript—and using the following HTML syntax:

<SCRIPT LANGUAGE=“JavaScript” SRC=“Invention.js”></SCRIPT>

In the line above the invention's source code is assumed to reside in a file named Invention.js. The web browser, upon seeing this directive will request the Invention.js file from the web server and integrate the contents of that file with the current page at the location of the <SCRIPT> tag.

As the page's source code is interpreted by the browser the functionality of the invention will be enabled for any ECMAScript which occurs later in the page or which accesses that page from an external frame. This strategy is the most prevalent mechanism used by today's web sites.

Second, a “server-side include” using an SHTML file could be utilized. In this model an HTML tag following this syntax is used:

<!—#include type=virtual src=”Invention.js—>

In this case a properly configured web server will automatically replace this line with the contents of the named file. As with the <SCRIPT> tag example, any subsequent ECMAScript on the page containing this tag will have the benefit of using the invention. The difference between the two approaches has to do with where the ECMAScript source is integrated with the enclosing page, on the client or on the server.

Notification

Note that the preferred embodiment rests on the foundation provided by the inheritance and encapsulation models described in the companion application, filed on the same day as this application, Docket No. 9087/1a and whose code is included in the Microfiche submission to this application.

The initialization process starts by creating the TPSignalMap object which will manage the data related to event registrations. Creation of this object is straightforward:

// create a subtype of TPObject for signal map control
TPObject.addSubtype(‘TPSignalMap’);
With the object created the next step is creation of the signal map data
structures
themselves:
// define dictionary for signal/origin entries
TPSignalMap.$interests = {};
TPSignalMap.$interests [‘$any’] = {};
TPSignalMap.$interests[‘$any’][‘$any’] = {‘$cap’:[], ‘$non’:[]};

As previously described the signal map is a set of nested data structures whose top level is populated by keys representing signal types. In the example above, the key “$any” is used to represent a NULL value. This special value is used by the functions which interact with the signal map when accessing registrations which should match any origin or signal type.

Functions to create and/or access the signal map entries are defined as follows:

// create a new map to manage the signal type provided
TPSignalMap.addTypeMethod(‘addSignalMap’,function(aSignal){

if (isValid(this.$interests[aSignal]))
{

return;

};
this.$interests[aSignal] = {};
this.$interests[aSignal][‘$any’] = {‘$cap’:[], ‘$non’:[]};

});
// return the map corresponding to the origin and signal type provided.
// NOTE the implicit conversion of null references to “$any” keys
TPSignalMap.addTypeMethod(‘getSignalMap’, function(anOrigin,
aSignal) {

if (!aSignal)
{

if (!anOrigin)
{

map = TPSignalMap.$interests[‘$any’][‘$any’];

} else {

if (notValid(TPSignalMap.$interests[‘$any’][anOrigin]))
{

TPSignalMap.$interests[‘$any’][anOrigin] =
{‘$cap’:[], ‘$non’:[]};

};
map = TPSignalMap.$interests[‘$any’][anOrigin];

};

} else {

if (!anOrigin)
{

if (notValid(TPSignalMap.$interests[aSignal]))
{

TPSignalMap.addSignalMap(aSignal);

};
map = TPSignalMap.$interests[aSignal][‘$any’];

} else {

if (notValid(TPSignalMap.$interests[aSignal]))
{

TPSignalMap.addSignalMap(aSignal);

};
if (notValid(TPSignalMap.$interests[aSignal][anOrigin]))
{

TPSignalMap.$interests[aSignal][anOrigin] =
{‘$cap’:[], ‘$non’:[]};

};
map = TPSignalMap.$interests[aSignal][anOrigin];

};

};
return map;

});
// notify all handlers in the map provided with the signal given
TPSignalMap.addTypeMethod(‘notifySignalMap’, function(map, signal){

var i;
if ((!map) ∥ (!signal))
{

return;

};
// capturing elements
for (i=0; i<map[‘$cap’].length; i++)
{

map[‘$cap’][i].handle(signal);

};
// non-capturing elements
for (i=0; i<map[‘$non’].length; i++)
{

map[‘$non’][i].handle(signal);

};

}
);

The previous functions, addSignalMap( ), getSignalMap( ), and notifySignalMap( ) provide common behavior of the TPSignalMap type itself. These functions are reused by registration and removal policy objects involved in direct signal map traversal and modification to effect changes and to acquire data from the underlying dictionary structures.

Registration Policies

When processing a registration request the signal map must be updated to store the necessary data. By encapsulating knowledge regarding the data structures of the signal map into functions owned by the type changes to the underlying data model can occur without altering the behavior of the rest of the system.This leads to a strategy in which knowledge about the structure of the signal map is contained in policy objects stored with the TPSignalMap type. This allows the specific data structures of the signal map to change in response to performance requirements etc. without having to rewrite large portions of the event system.

The current system map maintains separate data structures for capturing and non-capturing handlers. This leads to the development of two registration policy objects. The two are identical with the exception of one line where the key ($cap or $non) is altered based on the type as noted in the sample implementation below:

TPSignalMap.REGISTER_CAPTURING = function(reg)
{

/**
Handles registration of a capturing handler for the registration data
provided. The parameter is expected to contain values for ‘o’, ‘s’, and
‘h’ keys which are origins, signals, and handler respectively. Only the
handler is required.
*/
var map;
var origin;
var signal;
var handler;
if (!reg)
{

return;

};
// the get( ) function is an access method which will return
// the value of the named attribute
handler = reg.get(‘h’);
if (!handler)
{

return;

};
signal = reg.get(‘s’);
// is Valid translates into a test for != null
if (isValid(signal))
{

// isString translates to typeof(o) == typeof(““);
if (!isString(signal))
{

// getSignalName returns string representation
signal = signal.getSignalName( );

};

};
origin = reg.get(‘o’);
if (isValid(origin))
{

if (!isString(origin))
{

// note we use the ID of the origin
origin = origin.getID( );

};

};
// get the “$cap” (capturing) handler map instead of “$non”
// REGISTER_NONCAPTURING would use [‘$non’] here
map = TPSignalMap.getSignalMap(origin, signal)[‘$cap’];
map[map.length] = handler;

};

Removal Policies

When a removal request is received the appropriate entries need to be removed from the signal map so they no longer trigger. This process is the symmetrical opposite of registration. Note that since the origin and signal are represented in the signal map as keys the remaining data consists largely of the handler. This implies that for removal to occur properly the handler specified during registration must be supplied during removal.

As with the registration policies the removal policies are virtually identical for removing capturing vs. non-capturing event registrations. This is a side-effect of the current data structure which might not hold if the underlying data structures were modified significantly.

// remove a capturing handler entry
TPSignalMap.REMOVE_CAPTURING = function(reg)
{

/**
Removes registration of a capturing handler for the registration data
provided. The parameter is expected to contain values for ‘o’, ‘s’, and
‘h’ keys which are origins, signals, and handler respectively. Only the
handler is required.
*/
var i;
var index;
var map;
var origin;
var signal;
var handler;
if (!reg)
{

return;

};
handler = reg.get(‘h’);
if (!handler)
{

return;

};
signal = reg.get(‘s’);
if (isValid(signal))
{

if (!isString(signal))
{

signal = signal.getSignalName( );

};

};
origin = reg.get(‘o’);
if (isValid(origin))
{

if (!isString(origin))
{

origin = origin.getID( );

};

};
// REMOVE_NONCAPTURING would obviously use “$non” here
map = TPSignalMap.getSignalMap(origin, signal)[‘$cap’];
// find handler
index = −1;
for (i=0; i<map.length; i++)
{

if (map[i] === handler)
{

index = i;

};

};
// rip out handler
if (index>=0)
{

map.splice(index,1);

};

};

Observe and Ignore Handlers

Unlike previous event systems, in the approach defined by the invention, the registration and removal functions are invoked indirectly via handlers for Observe and Ignore signals rather than being invoked directly. This allows multiple observers for Observe and Ignore to exist with ease. The most dramatic effect of this change is that only signal( ) is a primitive operation. This is in contrast to existing systems in which signal, observe, and ignore are all primitives.

When an event registration or removal is required the request for activity is presented as a signal of the type Observe (for registrations) or Ignore (for removals). As with the rest of the event system, the result of a signal is the invocation of zero or more handlers. To ensure that Observe and Ignore events can be processed correctly the invention defines pre-built implementations of these two critical handlers.

TPSignalMap.$observe = function(sig)
{

/**
Default handler for Observe signals.
*/
var i;
var j;
var reg;
var origins;
var signals;
var handler;
var policy;
if (!sig)
{

return;

};
// suspend turns off event notification
suspend(true);
// get can signal “NotFound” which is why we suspend
origins = sig.get(‘anOrigin’);
signals = sig.get(‘aSignal’);
handler = sig.get(‘aHandler’);
policy = sig.get(‘aPolicy’);
// re-enable event notification
suspend(false);
origins = sig.get(‘anOrigin’);
// default the registration policy to a non-capturing model
policy = defaultIfInvalid(policy,

TPSignalMap.REGISTER_NONCAPTURING);

if (!isFunction(policy))
{

if (isFunction(TPSignalMap[policy]))
{

policy = TPSignalMap[policy];

}
else if (isString(policy) && (policy.toLowerCase( ) ==
“capture”))
{

policy = TPSignalMap.REGISTER_CAPTURING;

}
else
{

policy = TPSignalMap.REGISTER_NONCAPTURING;

};

};
origins = defaultIfInvalid(origins, [‘$any’]);
if (!isJSArray(origins))
{

origins = [origins];

};
signals = defaultIfInvalid(signals, [‘$any’]);
if (!isJSArray(signals))
{

signals = [signals];

};
for (i=0; i<origins.length; i++)
{

for (j=0; j<signals.length; j++)
{

reg = {‘o’:origins[i], ‘s’:signals[j], ‘h’:handler};
policy(reg);

};

};

};

In the Observe handler just presented the actual invocation occurs in the last line of code reading:

policy(reg);

Notice that the original parameters have been collected into a new “reg” object which represents the registration data. The registration and removal policies use this registration object format consistently. Note also that the process occurs inside two nested for loops which support the ability to register for complex combinations of origins and signals in a single Observe signal.

The Ignore handler is again a symmetrical opposite of the Observe handler. The job of the Ignore handler is to invoke a removal policy to remove any/all registrations specified.

TPSignalMap.$ignore = function(sig)
{

/**
Default handler for Ignore signals. Ignore signals are sent by the
$ignore call which bundles up the actual data in a simple object for
processing by handlers.
*/
var i;
var j;
var reg;
var origins;
var signals;
var handler;
var policy;
if (notValid(sig))
{

return;

};
suspend(true);
// capture the data we're really interested in
origins = sig.get(‘anOrigin’);
signals = sig.get(‘aSignal’);
handler = sig.get(‘aHandler’);
policy = sig.get(‘aPolicy’);
suspend(false);
policy = defaultIfInvalid(policy, TPSignalMap.REMOVE_{—}
NONCAPTURING);
if (!isFunction(policy))
{

if (isFunction(TPSignalMap[policy]))
{

policy = TPSignalMap[policy];

}
else if (isString(policy) && (policy.toLowerCase( ) ==
“capture”))
{

policy = TPSignalMap.REMOVE_CAPTURING;

}
else
{

policy = TPSignalMap.REMOVE_NONCAPTURING;

};

};
origins = defaultIfInvalid(origins, [‘$any’]);
if (!isJSArray(origins))
{

origins = [origins];

};
signals = defaultIfInvalid(signals, [‘$any’]);
if (!isJSArray(signals))
{

signals = [signals];

};
for (i=0; i<origins.length; i++)
{

for (j=0; j<signals.length; j++)
{

reg = {‘o’:origins[i], ‘s’:signals[j], ‘h’:handler};
policy(reg);

};

};

};

Installation of these handlers must be done manually to bootstrap the system. Once these handlers are installed the default firing policies will find them and future Observe and Ignore signals will be processed correctly.

// manually install default Ignore handler
TPSignalMap.addSignalMap(‘Ignore’);
TPSignalMap.getSignalMap(null, ‘Ignore’)[‘$non’][0] = TPSignalMap.
$ignore;
// manually install default Observe handler
TPSignalMap.addSignalMap(‘Observe’);
TPSignalMap.getSignalMap(null, ‘Observe’)[‘$non’][0] = TPSignalMap.
$observe;

In each pair of lines above our previously defined addSignalMap( ) call is used to create a signal map entry data structure for the signal type in question (Observe or Ignore). The second line in each pair manually installs the Observe or Ignore handler as appropriate. Note the use of the getSignalMap( ) function to acquire a handle to the signal map entry for the signal type. In each case the origin is provided as a NULL reference. Observe and Ignore signals aren't typically origin-specific so the use of NULL ensures that all such signals will be processed.

Signaling

With registration and removal occurring as a result of signals the only true primitive operation in the invention becomes signaling. As defined earlier, a signal is initiated using signal( ) as in:

signal(origin, signal, context, policy, additionalArgurnents)

The actual implementation of the signal function itself is straightforward:

signal = function(anOrigin, aSignal, aContext, aPolicy)
{

/*
Trigger the appropriate firing policy to notify observers.
*/
var i;
var args;
// see if ignore is on. the suspend( ) function controls this flag
if (arguments.callee[‘$suspend’])
{

return;

};
// capture any additional arguments not named in function def
args = [];
for (i=4; i<arguments.length; i++)
{

args[args.length] = arguments[i];

};
if (!isFunction(aPolicy))
{

// if the policy is a string name see if we can find it
// as a type variable on the signal map type object
if (isFunction(TPSignalMap[aPolicy]))
{

aPolicy = TPSignalMap[aPolicy];

}
else
{

// if all else fails default to a simple policy
// that will notify observers
aPolicy = TPSignalMap.DEFAULT_FIRING;

};

};
// insert origin, signal, and context in from of other arguments
args.splice(0, 0, anOrigin, aSignal, aContext);
// invoke policy with arguments as assembled
return aPolicy.apply(this, args);

};

As previously presented the ultimate effect of the signal( ) function is to invoke a firing policy with the various arguments supplied to the signal function. This approach further simplifies the essential framework of the signaling system since it implies that virtually everything that occurs in the event system is controlled by policy objects or handlers. This flexibility is critical to supporting the differing requirements of DOM events, non-DOM events, Exceptions, etc.

Firing Policies

The different signal types in the system require different semantics to process them properly. Exceptions follow an inheritance hierarchy when determining whether to continue traversal. If an exception of a more general type is being observed and no handler has yet handled the exception the system must continue looking for registrations of more and more general exception types until all options are exhausted. This traversal pattern is different for DOM events. In the processing of DOM events the chain to be followed is defined by the containment hierarchy of the document—not by inheritance. To support these differing requirements the invention uses “firing policies”. A firing policy is essentially a function whose logic determines how a particular action will take place. The invention defines three pre-built firing policies: DEFAULT_FIRING, DOM_FIRING, and EXCEPTION_FIRING. The three are presented in the pages that follow:

// standard firing policy
TPSignalMap.DEFAULT_FIRING = function(originSet, signalSet,
aContext)
{

/**
Fires a series of signals from a series of origins. Typically this
method is called with one signal and one origin but it's capable of
processing arrays of either.
*/
var i;
var j;
var args;
var sig;
var signal;
var map;
// don't bother without signal(s)
if (!signalSet)
{

return;

};
// make sure we have an array of signals
// isJSArray is a wrapper for a typeof( ) call to check array
if (!isJSArray(signalSet))
{

signalSet = [signalSet];

};
// make sure we have an array of origins that includes the special
// $any reference that will cover observers of each signal
// regardless of its origin
// the defaultIfInvalid call returns the second parameter if the
// first parameter is null or undefined
originSet = defaultIfInvalid(originSet, []);
if (!isJSArray(originSet))
{

originSet = [originSet];

};
originSet[originSet.length] = ‘$any’;
// capture args
args = [];
for (i=3; i<arguments.length; i++)
{

args[args.length] = arguments[i];

};
// process whatever signals we have from at least the default origin
for (j=0; j<signalSet.length; j++)
{

signal = signalSet[j];
// create proper signal type and instance as needed
if (isString(signal))
{

// the getTypeWithName call attempts to locate the
// type by looking in a global dictionary or by
// testing via self[typename] for a type object
if (notValid(getTypeWithName(signal)))
{

// here we create a new signal subtype if the
// signal type doesn't yet exist. the addSubtype
// call is from the Improved Inheritance model
signal = TPSignal.addSubtype(signal);

};
// finally we create a new instance of the signal type
// that has any/all optional arguments which were passed
// to the policy. this does not include origin, signal,
// handler, or policy
str = signal.getSignalName( ) +‘.create(’+

buildArgStringOverRange(3, arguments.length) +
‘);’;

sig = eval(str);

}
else
{

sig = signal.create.apply(signal, args);

};
// make sure we're dealing with true signals. isKindOf( )
// checks all supertype data to make sure the instance
// inherits from the type provided somewhere in the hierarchy
if ((!sig) ∥ (!sig.isKindOf(TPSignal)))
{

// skip this one
continue;

};
// configure the signal instance. each signal should have a
// source context (usually via arguments.callee)
sig.setContext(aContext);
// iterate over all origins and signal as if from each
for (i=0; i<originSet.length; i++)
{

// update origin as we go
sig.setOrigin(originSet[i]);
// notify observers of the specific signal/origin
// NOTE that this will cover signal/$any since we make
// sure that's part of the list up front
// Notice the use of the notifySignalMap( ) call here
TPSignalMap.notifySignalMap(
TPSignalMap.getSignalMap(originSet[i],

sig.getSignalName( )),
sig);

```
// notify observers of $any signal registered at origin
// NOTE that this will cover $any/$any since we make
// sure that's part of the list
// Again, note use of notifySignalMap call here
TPSignalMap.notifySignalMap(
  TPSignalMap.getSignalMap(originSet[i], null),
  sig);
```

};

};

};

As the previous function shows, the logic involved in a firing policy can be extensive. To simplify some of the processing the firing policies support multiple origins, multiple signals, or combinations thereof. The default policy is capable of handing sets of both origins and signals.

DOM Firing

The DOM firing policy restricts its operation to triggering a single signal across a set of origins. The origin set for the DOM policy is assumed to reflect the proper containment hierarchy. The invention accomplishes assembly of this origin set using a set of functions presented later under the subheading of Integrating Web Page Events. One important distinction with DOM firing is the interaction of capturing and non-capturing handlers. For DOM firing the changes from the default firing policy have to do with traversing properly through capturing and non-capturing registrations while ensuring that the “stop propagation” logic required for DOM event processing is maintained.

// fire DOM style
TPSignalMap.DOM_FIRING = function(originSet, aSignal, aContext)
{

var i;
var j;
var args;
var targetReached = false;
var target;
var sig;
var map;
// in the DOM model we can only fire if we have a signal and origin
if ((!aSignal) ∥ (!originSet))
{

return;

};
// one or more origins are required...the origins are provided by
// the originator of the call.
if (!isJSArray(originSet))
{

originSet = [originSet];

};
// capture args
args = [];
for (i=3; i<arguments.length; i++)
{

args[args.length] = arguments.length;

};
// create proper signal type and instance as needed. we require a
// real signal instance for proper signaling
if (isString(aSignal))
{

if (notValid(getTypeWithName(aSignal)))
{

aSignal = TPSignal.addSubtype(aSignal);

};
str = aSignal.getSignalName( ) + ‘.create(‘ +

buildArgStringOverRange(3, arguments.length) +
’);’;

sig = eval(str);

}
else
{

sig = aSignal.create.apply(aSignal, args);

};
if (!sig ∥ (!sig.isKindOf(TPSignal)))
{

return;

};
// configure the signal instance with any passed argument data
sig.setContext(aContext);
// where was the signal aimed. In DOM events there is always a
// target element which is the “innermost” element in the document's
// containment hierarchy. that's the target of the event
target = sig.getTarget( );
// process the signal across the set of origins checking for stop
// behavior at each level
for (i=0; i<originSet.length; i++)
{

// be sure to update the signal as we rotate origins
sig.setOrigin(originSet[i]);
// are we on the way down or up?
if (targetReached ∥ (originSet[i] == target))
{

targetReached = true;

};
// since we're doing a capturing model we work from general to
// specific. start with $any/$any
map = TPSignalMap.getSignalMap(null, null);
if (!targetReached)
{

// first we run all capturing handlers
for (j=0; j<map[‘$cap’].length; j++)
{

map[‘$cap’][j].handle(sig);

};
// should we stop or move on to non-capturing
if (sig.shouldStop( ))
{

break;

};

}
else
{

// if we're moving on we have to tell them all
for (j=0; j<map[‘$non’].length; j++)
{

map[‘$non’][j].handle(sig);

};

};
if (sig.shouldStop( ))
{

break;

};
// let $any/origin listeners see the signal. these might
// include blanket capturing handlers
map = TPSignalMap.getSignalMap(originSet[i], null);
if (!targetReached)
{

// first we run all capturing handlers
for (j=0; j<map[‘$cap’].length; j++)
{

map[‘$cap’][j].handle(sig);

};
// should we stop or move on to non-capturing
if (sig.shouldStop( ))
{

break;

};

}
else
{

// if we′re moving on we have to tell them all
for (j=0; j<map[‘$non’].length; j++)
{

map[‘$non’][j].handle(sig);

};

};
if (sig.shouldStop( ))
{

break;

};
// no ‘blanket’ capturers so move on to signal-specific ones
map = TPSignalMap.getSignalMap(originSet[i],
sig.getSignalName( ));
if (!targetReached)
{

// first we run all capturing handlers
for (j=0; j<map[‘$cap’].length; j++)
{

map[‘$cap’][j].handle(sig);

};
// should we stop or move on to non-capturing
if (sig.shouldStop( ))
{

break;

};

}
else
{

// if we're moving on we have to tell them all
for (j=0; j<map[‘$non’].length; j++)
{

map[‘$non’][j].handle(sig);

};

};
if (sig.shouldStop( ))
{

break;

};
// down to signal/$any
map = TPSignalMap.getSignalMap(null, sig.getSignalName( ));
if (!targetReached)
{

// first we run all capturing handlers
for (j=0; j<map[‘$cap’].length; j++)
{

map[‘$cap’][j].handle(sig);

};
// should we stop or move on to non-capturing
if (sig.shouldStop( ))
{

break;

};

}
else
{

// if we're moving on we have to tell them all
for (j=0; j<map[‘$non’].length; j++)
{

map[‘$non’][j].handle(sig);

};

};
if (sig.shouldStop( ))
{

break;

};

};

};

Exception Firing

The final pre-defined policy is EXCEPTION_FIRING. In this model the traversal is performed by continuing the signaling process until a handler sets the flag signifying that the exception has been handled.

Unlike the DOM model where a single signal is mapped across a set of origins, Exception processing maps a set of signals across a single origin. This is consistent with standard exception handling behavior. The origin remains the same throughout. The first signal attempted is the “most specific” error/exception type. Traversal continues through the signal set working from most specific to least specific error/exception type until a handler sets the stop propagation flag. This process is analogous to normal exception handling.

TPSignalMap.EXCEPTION_FIRING = function(anOrigin, signalSet,
aContext)
{

// declare our stuff
var i;
var j;
var sig;
var args;
var map;
var signal;
// in the exception model we have multiple signals but only one
// origin
if (isJSArray(anOrigin))
{

if (anOrigin.length >= 1)
{

logError(
‘Invalid Origin Array For Firing Policy. Truncating.’);
anOrigin = anOrigin[0];

}
else // oops, empty array
{

// clear empty array reference and rely on defaulting
anOrigin = null;

};

};
// make sure signals are in an array for loop control.
signalSet = defaultIfInvalid(signalSet, []);
if (!isJSArray(signalSet))
{

signalSet = [signalSet];

};
// capture args
args = [];
for (i=3; i<arguments.length; i++)
{

args[args.length] = arguments[i];

};
// process the list
for (i=0; i<signalSet.length; i++)
{

signal = signalSet[i];
// create proper signal type and instance as needed
if (isString(signal))
{

if (notValid(getTypeWithName(signal)))
{

signal = TPSignal.addSubtype(signal);

};
str = signal.getSignalName( ) + ‘.create(’ +

buildArgStringOverRange(3, arguments.length) +
‘);’;

sig = eval(str);

}
else
{

sig = signal.create.apply(signal, args);

};
// make sure we're dealing with exceptions
if (!sig ∥ (!sig.isKindOf(TPException)))
{

return;

};
// configure the signal instance
sig.setContext(aContext);
sig.setOrigin(anOrigin);
// notify specific observers for the signal
TPSignalMap.notifySignalMap(

TPSignalMap.getSignalMap(anOrigin,
sig.getSignalName( )),
sig);

if (sig.shouldStop( ))
{

break;

};
// notify global observers for signal/$any the signal
// occured if we didn't just do that:)
if (isValid(anOrigin))
{

TPSignalMap.notifySignalMap(

TPSignalMap.getSignalMap(null,
sig.getSignalName( )),
sig);

};
if (sig.shouldStop( ))
{

break;

};
// notify global observers for $any/$any the signal occured
TPSignalMap.notifySignalMap(

TPSignalMap.getSignalMap(null, null),
sig);

if (sig.shouldStop( ))
{

break;

};

};

};

The three pre-defined firing policies are only examples of what is possible via the policy pattern. The invention's use of policies allows programmers to create whatever logic is necessary to accomplish their specific event notification goals.

Activating Native Objects

Given a system in which observation of events can occur the question becomes which events to observe. Native ECMAScript doesn't support event notification for Array objects or any other non-DOM component however it does support modification of the Array.prototype object. This object determines the behavior of all instances of Array which are created within the system. By placing appropriate functions on this object is it possible to create Array behavior which will notify observers of various state changes or other activity. For example:

Array.prototype.add = function(anElement)
{

this[this.length] = anElement;
signal(this, “OnChange”, arguments.callee);

};
var handler = function(sig) { alert(‘State Changed!’) };
var myArray = new Array( );
observe(myArray, “OnChange”, handler);
myArray.add(1);

Execution of the previous code in a system using the invention will result in an alert panel displaying “State Change!”. A more robust program would perhaps redisplay an HTML table which was displaying the array's data.

The strategy used to modify Array.prototype can be used to update each of the built-in ECMAScript objects such that behavior of the built-in objects is augmented with the ability to signal appropriate events. Another example of an appropriate event would be an exception:

Array.prototype.add = function(anElement)
{

if (this.length == this.capacity)
{

return warn(“ArrayOverflow”, arguments.callee);

};
this[this.length] = anElement;
signal(this, “OnChange”, arguments.callee);

};

In this example our add( ) function has been updated to signal an “ArrayOverflow” event when an add attempts to exceed the array's setting for “capacity”—a hypothetical instance variable.

Observers of exceptions would be able to respond to this event and take appropriate action. The ability to use the event system provided by the invention for exceptions and error handling is a significant addition to the ECMAScript language.

Simulating Exceptions and Exception Handling

As discussed previously the invention defines four functions which assist ECMAScript programmers with respect to exception handling behavior. Those four functions are assert( ), attempt( ), die( ), and warn( ). Each of these functions is presented in the pages that follow.

assert( )

The assert( ) call is a simple function providing a mechanism for testing pre/post conditions. In robust programming environments it is common to test parameters etc. The assert( ) function provides a framework for such tests in which—if the test fails( ) a signal is initiated.

The signal raised by assert( ) by default is AssertionFailed, a subtype of TPException such that observers of TPException or its subtypes can be alerted to the fact that a problem has occured.

assert = function(aTest, anException, aContext)
{

/**
Raises an exception if the test provided evaluates to false. The test
should return a boolean value. The context is whatever the calling
context for assert is (normally arguments.callee) and the exception is
whatever exception should be thrown (the default is AssertionFailed).
Typical calls look like:

assert(isValid(param));
assert(param.isPositive( )), null, arguments.callee);
assert(param.isPositive( )), ‘InvalidNegativeIndex’);
assert(param.isPositive( )), ‘InvalidNegativeIndex’,

arguments.callee);

What happens on assertion failures depends on the handlers which are
registered via observe( ). At the local scope level assert( ) returns a
boolean regarding the test's completion status.
*/
var i;
var args;
if (!aTest)
{

anException = defaultIfInvalid(anException, ‘AssertionFailed’);
// assemble params for a valid $signal( ) call
args = [];
args[args.length] = this;
args[args.length] = anException;
args[args.length] = aContext;
// add additional optional arguments
for (i=3;i<arguments.length;i++)
{

args[args.length] = arguments[i];

};
// signal and let observers handle fallout
warn.apply(this, args);
return false;

};
return true;

};

attempt( )

The attempt( ) function provides a simple emulation of try/catch behavior with a twist. Prior to executing the function passed as the first parameter attempt( ) sets up an observation for any TPExceptions which might be thrown by that function. The function is then invoked and if an exception occurs during processing the handler provided is invoked. Upon return from the function the observation is removed via a call to ignore( ). Alternate versions of attempt( ) can take a dictionary of key/value pairs where the keys are exception types and the values are handlers for each of the specified exception types. An additional function passed as a “finally” parameter can optionally be executed just prior to return to allow attempt( ) to fully simulate try/catch/finally.

attempt = function(aFunction, anException, aHandler)
{

/**
Attempts to run the Function provided & notifies the handler listed if
exceptions are thrown by the function during execution. This is a
primitive stand-in for real try/catch for environments which are not
running a JS1.5 implementation.
A typical call might be:

attempt(this.doIt( ),

function(exception){alert(‘oops’+exception)});

*/
assert(isFunction(aFunction), null, arguments.callee);
assert(isValid(aHandler), null, arguments.callee);
anException = defaultIfInvalid(anException, ‘TPException’);
$observe(aFunction, anException, aHandler);
aFunction( );
$ignore(aFunction, anException, aHandler);
return;

};

die( )

The die( ) function is a simple mechanism for signaling an error and then causing the ECMAScript interpreter to stop processing due to true error. This function is a simple way to signal that something is wrong and to terminate execution of the script in question.

die = function(anOrigin, anExceptionType, aContext)
{

/**
Raises an exception and halts the interpreter as close to the error
as possible for debugging. This should only be called when
continuing would likely cause data corruption or a similarly serious
issue.
*/
// !!! make sure to supply a policy here
$signal.apply(this, arguments);
// generate a fatal interpreter error here to avoid continuing
eval(‘die’);
return;

};

Note that in a ECMAScript 1.5 environment die( ) could actually control the flow of the system by using the built-in try/catch functionality to throw a native ECMAScript exception. That exception could be managed (caught) but the proper effect of terminating the current script's operation would have been accomplished. Control will not return to the line after the die( ) call if die( ) throws a native ECMAScript exception.

warn( )

Like die( ), warn( ) signals an exception. Unlike die( ) however, warn( ) does not cause execution of the script to stop. In the earlier Array.prototype.add( ) example the warn( ) call was used in its typical way by placing it behind the “return” keyword. If the warning is signaled control returns to the calling function. This function can then attempt to repair the damage before moving on.

warn = function(anOrigin, anExceptionType, aContext)
{

/**
Raise an exception. Exception type can be either a type or a string
representing a type as appropriate. The calling context should be a
reference to the function in which the warning was issued. This is
usually provided as arguments.callee (too bad about caller isn't it).
*/
var i;
var supers;
var signal;
var args = [];
var exceptions = [];
if (anExceptionType == ‘TPException’)
{

logError(getCallStack(arguments.callee));

};
// collect arguments
for (i=4; i<arguments.length; i++)
{

args[args.length] = arguments[i];

};
// convert string exceptions into types
if (isString(anExceptionType))
{

signal = getTypeWithName(anExceptionType);
if (notValid(signal))
{

signal = TPException.addSubtype(anExceptionType);

};

}
else
{

signal = anExceptionType;

};
if (isValid(signal) && (signal.isSubtypeOf(TPException)))
{

supers = signal.getSupertypes( );

}
else
{

// add exception type (which isn't a proper exception) to args
args.splice(0,0,signal);
// signal a generic exception
signal = TPException;
supers = [];

};
// process supertype list to build exception tree
exceptions[exceptions.length] = signal;
for (i=0; i<supers.length;i++)
{

exceptions [exceptions.length] = supers[i];
if (supers[i] == TPException)
{

break;

};

};
// dispatch with EXCEPTION firing policy
args.splice(0, 0, anOrigin, exceptions, aContext,
“EXCEPTION_FIRING”);
$signal.apply(this, args);
return;

};

Note the use of the EXCEPTION_FIRING policy designation. The warn( ) call expects to have a signal which is some form of TPException and therefore it uses the EXCEPTION_FIRING policy to ensure proper traversal of the inheritance hierarchy occurs during signal firing. The warn( ) call creates the list of supertype exceptions to traverse by requesting a list of supertypes from the exception being signaled.

Integrating Web Page Events

The native ECMAScript event models require one of two mechanisms for event registration. In pre-DOM Level 2 implementations event handlers must be placed directly on the object observed. In DOM Level 2 implementations the “addListener” call must be used to register one or more listeners for a particular event. There are two alternatives for integrating these models with the model provided by the invention: integration of the native DOM events with the invention's event system without emulating DOM Level 2—OR—emulation of DOM Level 2 semantics for pre-DOM Level 2 browsers.

Integration

When the goal is simply to support integration of existing event implementations with the inventions' event system but not to emulate DOM Level 2, a simple “triggering” event handler can be registered on each origin in response to the observe( ) function.

For pre-DOM Level 2 implementations this means that as part of the observe( ) process a handler must be placed directly on the object being observed in the appropriate event handler slot. For DOM Level 2 implementations it means invoking the addListener( ) function to add the listener to the origin. In both cases the triggering handler will signal the invention's peer event (as earlier described) as having originated from the origin. A specific example helps clarify things.

Assume the following observe call is made:

observe(myButton, “OnClick”, function(sig) {alert(‘clicked!’) };

This function, as previously described, will result in a registration for the HTML element whose object reference is myButton for signals of type “OnClick”. When a match is found the function whose output is an alert panel declaring “clicked!” will be triggered. The problem is that for the initial event to be signaled a function must be placed on the button in question or added as a listener depending on the event model in force in the current DOM implementation.

The invention's solution is to augment the registration policies so that signals which are subtypes of TPNativeSignal undergo additional registration processing. This is accomplished by implementing a register( ) function on TPSignal such that all signal types can respond to a request to register. The registration policies then message each signal type they process with a call to register( ). The signal type responds with type-specific behavior while the registration policies remain consistent for all signal types.

The default implementation of register( ) on TPSignal is to do nothing since for non-DOM signals no additional processing is required. For TPNativeSignal and its subtypes however the register( ) function performs the additional processing required to “instrument” the native object with an appropriate triggering handler via direct assignment or the addListener( ) call.

A triggering handler is a simple function resembling the following:

function(e)
{

var target;
// capture event object if we're in IE
if (navigator.appName.indexOf(“Microsoft”) != −1)
{

e = window.event;
target = e.srcElement;

}
else
{

target = e.target;

};
// signal the event in invention format and pass along
// the actual event data for use
signal(target, signalType, arguments.callee, null, e);

};

When the native event invokes this handler it will either pass the event as a parameter (Navigator) or set it as a global (Internet Explorer). In either case the origin is captured from the event object and then a signal in the form expected by the invention is triggered. The invention's event system processes this signal and the result is activation of any registered handlers.

For DOM Level 2 implementations Function.prototype must be augmented with a handleEvent( ) function which will invoke the receiving function so that invocation of the listener can be done properly. This is accomplished in the same fashion as the handle( ) call defined earlier. If the handleEvent operation is already supported this step is unnecessary.

Emulation

Emulation of DOM Level 2 behavior is more complex. Each existing browser supports a different model for event propagation and therefore requires a different implementation to operate correctly. The goal in all cases is the capture of the DOM containment hierarchy for passage to the invention's signaling system and the DOM_FIRING policy.

For DOM Level 2 compliant browsers emulation isn't necessary since these browsers already support the proper semantics. However, to integrate the native event system with the event system of the invention it is necessary to add a listener to the document which captures all events.

When this handler is invoked it must:

Create two arrays.

Working from the event target upward through the DOM parent references store each object in the DOM object hierarchy from the event target up to the document which encloses it at the top of the DOM tree on the end of the first array and the beginning of the second array. The first array now begins with the target element and ends with the document while the second array begins with the document and ends with the target.

splices the first array onto the second array such that only one reference to the target object exists. The resulting second array now contains a list of the objects from the document to the target and back to the document. This represents the order of the objects with respect to DOM Level 2 dispatch ordering. The second array is now properly configured to drive the DOM_FIRING policy with respect to origins.

Signal the original event's peer event type (onclick becomes OnClick etc.) using the invention's signal( ) call and the array of objects captured from the DOM. Specify the DOM_FIRING policy to ensure proper emulation of the DOM Level 2 event system.

Using this approach the native event system semantics are preserved while unifying the two event systems. Events which are triggered in the native system are converted and re-dispatched.

For Internet Explorer the operation is similar to that for DOM Level 2 environments. A document-level handler performing the steps defined above must be installed. A difference exists however since not all events bubble to the document. For any events which are observed( ) for which bubbling does not occur a direct assignment of a triggering handler must be made. This triggering handler should perform the same operation as the document-level handler to capture the DOM tree and signal the peer event and DOM origin array with a DOM_FIRING policy. For certain events this process isn't necessary. For example, the onclick (OnClick) event isn't relevant to many of the objects in the DOM and may have only been observed for the Button which was clicked. In this case the system can optimize behavior by using a simple triggering handler rather than the more complex DOM capturing handler.

For Netscape Navigator prior to version 6 a more complex model must be used. Navigator prior to version 6 doesn't support a true DOM tree which can be traversed to determine containment. Although Navigator does support the capturing model there is no way to use a document-level handler alone to create the complete to hierarchy between the document and the target object in question. On the other hand, Navigator doesn't support a deep hierarchy. All elements in Navigator are essentially available directly under the document or layer objects. Traversal of the document and layer hierarchy is possible and adequate for the events which Navigator supports.

The result is a strategy similar to that for Internet Explorer. Placement of a document-level capturing handler is first. When any event which is being observed occurs this top-level handler is invoked. The handler then performs the following steps:

Create an array.

Traverse the document's elements array to locate the event target. If the target is found place the document, the target, and the document in the array. This is now the DOM containment hierarchy for the element. If the target isn't found traverse each of the element arrays for the layers in the document's layers array. Using the information in the layers construct the DOM containment hierarchy for the element such that the array starts and ends with the document and descends through the appropriate layers until the target object which is contained in the center of the array.

Signal the original event's peer event type (onclick becomes OnClick etc.) using the invention's signal( ) call and the array of objects captured from the DOM. Specify the DOM_FIRING policy to ensure proper emulation of the DOM Level 2 event system.

Using this approach it is possible to approximate DOM Level 2 dispatch semantics for each of the three event propagation models and DOM hierarchies currently in wide deployment.

Note that the DOM hierarchy information which is captured by this approach for Navigator could be cached or reconstructed into an actual tree such that overhead was reduced across multiple calls to the handler. The handler can use the cached information regarding page structure if the cache has been constructed and can use the information captured to create a cached model of the page when no cache yet exists.

Additional Embodiments

An advancement over the signal map functions defined so far would make use of ECMAScript's built-in support for Regular Expressions via the RegExp object.

Using RegExp instances to define criteria for matching to either a signal type or origin would add power to the system. In the existing system a top-level $interests dictionary is used to store keys for the signal types with registrations. The values of these keys are second-level dictionaries storing IDs for the origins being observed for each signal. The use of dictionaries allows for fast lookup of exact string matches. To support RegExp matching each dictionary's keys could be iterated upon and each key would be checked via the RegExp test( ) function. This function returns true if the string parameter passed to it matches the regular expression. The resulting key would then be traversed and any registrations found would be processed in the normal fashion.

A second addition to the existing system would be the addition of signal guards. In the preferred embodiment each handler has an optional guard function which can be used to filter against particular signals. As previously described when a signal is matched against a registration that registration's guard function—if any—is invoked with the signal as a parameter. If the guard returns true access to the handler is acceptable. If the guard returns false the handler should not be invoked. This approach can be expanded to work in both directions. As an additional parameter to the signals function a guard function can be provided. This alteration would change the syntax to something resembling:

signal(origin(s), signal(s), context, policy, guard, more args . . . );

When matching handlers are found the firing policy would be updated to not only pass the signal to the handler's guard function but to pass the handler to the signals' guard function. Only if both guards approved would the signal actually be dispatched to the handler. This change could be made by supplying a new firing policy which would expect a signal guard function. The existing policy functions would remain unchanged.

Alternative Embodiments

A multitude of options exist for storing the signal map entries. These structures could be organized with the origins first, with signals first, with signals and origins merged via some connecting syntax such as signal:origin etc. The segmentation between capturing and non-capturing could be eliminated and treated as an attribute of the registrations themselves. The variations for data storage are innumerable. Each of the various pre-defined policies could be implemented in a variety of ways. The EXCEPTION_FIRING policy for example could assemble the inheritance hierarchy itself rather than depending on the warn( ) call. Alternate strategies for default firing are also possible. These alterations could be made either by replacing the existing policy objects or by implementing additional policy objects.

The observe and ignore mechanisms could be implemented as primitives rather than as signals to improve performance for certain operations. Guard functions are not required.

Conclusions, Ramifications, and Scope

The invention addresses a serious set of issues with respect to event-based program development in ECMAScript. The failure of the existing web browsers to support a single unified event model severely limits the scope of applications which can be constructed. The further failure of the ECMAScript and DOM standards committees to address event notification outside the scope of DOM-specific events only adds to the problem.

The invention solves these collective problems by supporting a common, unified, and bi-directional event notification system that not only enables robust event-based programs but allows the events in those programs to be distributed and observed by remote entities. This event system can run in any ECMAScript compliant environment allowing it to be used effectively in all version 4 and later version browsers. The result is true compatibility for event-based programs.

The additional advantages of the invention including simplification of the system to a single primitive operation (signal); policy-based registration, removal, and triggering; remote event observation and notification; and the addition of event-based exception handling constructs are also significant improvements to the ECMAScript and web programming environments.

With respect to each area of this invention it should be noted that the specific implementation described here is exemplary in nature and accordingly, the scope of the invention should be determined not by the embodiment(s) illustrated but by the appended claims and their legal equivalents.

1. A method for implementing event notification in ECMAScript consisting of:
a signaling function for signaling events
a registration event signaled by said signaling function which triggers event registration to occur
a removal event signaled by said signaling function which triggers registration removal to occur

2. In addition to claim 1, use of a common data structure to store registrations of interest in event notification from document object model (DOM) elements or objects, non-DOM elements or objects, and remote elements or objects collectively.

3. In addition to claim 1, use of a function whose operation consists of being invoked in response to said registration event and relaying said registration event to a remote object

4. In addition to claim 1, use of a function whose operation consists of being invoked in response to said removal event and relaying said removal event to a remote object

5. In addition to claim 1, use of a function or set of functions whose operation consists of being registered as native ECMAScript event handlers and of converting said native ECMAScript events when triggered into a form suitable for use with said signaling function

6. In addition to claim 1, modification of non-DOM ECMAScript object types including Array, Object, String, Number, Date, Boolean, and RegExp such that state changes to these types and their instances trigger invocation of said signaling function

7. Use of a function or set of functions installed as native ECMAScript event handlers whose invocation consists of capturing the document object model (DOM) containment hierarchy of the document in which they reside.

8. In addition to claim 7, use of a function which utilizes said containment hierarchy to propagate the event which triggered the function or functions to capture said containment hierarchy.

9. In addition to claim 1, use of a function whose operation consists of registering interest in signals representing exceptions originating from a function, invoking said function, and subsequently removing registration of said observations.
